(19) United States
(12) Patent Application Publication
(10) Pub. No.: US 2025/0302051 A1
(43) Pub. Date: Oct. 2, 2025

(54) COMPOSITIONS WITH NANOPLATELET OXIDES OR HYDROXIDES AND METHODS OF PREPARING AND USING SAME

(71) Applicant: Aqua Resources Corporation, Shalimar, FL (US)

(72) Inventors: Orville Lee Maddan, Fort Walton Beach, FL (US); John Cairney, Fort Walton Beach, FL (US)

(21) Appl. No.: 19/097,654

(22) Filed: Apr. 1, 2025

Related U.S. Application Data
(60) Provisional application No. 63/573,245, filed on Apr. 2, 2024.

(51) Int. Cl. A01N 65/22; A01N 25/12; A01P 1/00; A01P 7/02; A01P 7/04

(52) U.S. Cl. CPC A01N 65/22; A01N 25/12; A01P 1/00; A01P 7/02; A01P 7/04

(57) ABSTRACT

Nanoplatelets having a metal oxide or hydroxide monolayer are provided, as well as methods for preparing same. The nanoplatelets are suitable for use in pesticide compositions capable of deterring pests, including microbes. The nanoplatelets are suitable for use in food processing aids for their technical and functional effect in the processing, and are present in the finished food at insignificant levels and do not have any technical or functional effect in the finished food. The nanoplatelet forms include oxide or hydroxide nanoplatelets.

### FIELD

Nanoplatelets having a metal oxide or hydroxide monolayer are provided, as well as methods for preparing same. The nanoplatelets are suitable for use in improved food processing aids to allow faster, technical and functional results. The nanoplatelet forms include magnesium hydroxide nanoplatelets.

### BACKGROUND

The food additive, processing and food producing industries have chemicals that are toxic to varying degrees but not as dangerous as no treatment at all. What is needed is a new effective method that uses a safer form of chemical that will not hurt someone who inhales, consumes, or contacts it, is safe to the environment and has a wider perspective of pests it defeats. The regulatory scheme in the EPA under title 40 of the CFR handles pesticides and environment and the FDA under title 21 CFR handles the foods and food additives.

The EPA regulatory scheme is such that some pesticides are considered so safe that they are exempt from the EPA required pesticides registration, such as the minimum risk pesticides depicted in 40 CFR 152.25(f). Many of the active ingredients of those pesticides can be bound to nanoplatelets greatly extending the effective working lifetime of the pesticide. The active ingredients of these minimum risk pesticides can be used in processing of commonly consumed food commodities that have tolerance exemptions such as those in 40 CFR 180.950:
“Tolerance exemptions for minimal risk active and inert ingredients. Unless specifically excluded, residues resulting from the use of the following substances as either an inert or an active ingredient in a pesticide chemical formulation, including antimicrobial pesticide chemicals, are exempted from the requirement of a tolerance under FFDCA section 408, if such use is in accordance with good agricultural or manufacturing practices”.

The FDA regulatory scheme is such that some food additives are listed as GRAS, Generally Recognized As Safe, for their intended use, within the meaning of section 409 of the Act. See, for example, 21 CFR 182.20 Essential oils, (table incorporated by reference), In accordance with 21 CFR 101.22(j) where the essential oil(s) is/are added to foods as a chemical preservative(s), the foods shall, except when exempt pursuant to § 101.100 bear a label declaration. Magnesium hydroxide is added as a processing aid. See 21 C.F.R. 184.1428. This allows these two food additives for their technical and functional effect in the processing and the additives are present in the finished food at insignificant levels that do not have any technical or functional effect in that food. See 21 CFR 101.100(a)(3)(ii)(c).

Certain foods are exempt 21 CFR 101.100(a) under from the requirements of section 403(i)(2) of the Federal Food, Drug, and Cosmetic Act, requiring a declaration on the label of the common or usual name of each ingredient when the food is fabricated from two or more ingredients. Among the exceptions are incidental additives that are present in a food at insignificant levels and do not have any technical or functional effect in that food. See 21 CFR 101.100(a)(3). Under 21 CFR 101.100(a)(3)(ii), for the purposes of paragraph (a)(3), incidental additives include “Processing aids”, which include “substances that are added to a food for their technical or functional effect in the processing but are present in the finished food at insignificant levels and do not have any technical or functional effect in that food.” See 21 CFR 101.100(a)(3)(ii)(c).

### SUMMARY OF THE DISCLOSURE

A method of producing monolayer metal hydroxides and metal oxides of superior properties is desirable. The materials and methods disclosed herein can be employed to prepare such metal hydroxides and metal oxides in form a monolayer nanoplatelet, nanotube, and other forms.

Oxides and hydroxides that can be prepared according to the preferred embodiments include MgO, SrO, BaO, CaO, TiO₂, ZrO₂, FeO, V₂O₃, V₂O₅, Mn₂O₃, Fe₂O₃, NiO, Ni₂O₃, CuO, Al₂O₃, SiO₂, ZnO, Ag₂O, [Ce(NO₃)₃—Cu(NO₃)₂] TiO₂, Mg(OH)₂, Ca(OH)₂, Al(OH)₃, Sr(OH)₂, Ba(OH)₂, Fe(OH)₃, Cu(OH)₃, Ni(OH)₂, Co(OH)₂, Zn(OH)₂, AgOH, mixed metal oxides, mixed metal hydroxides, and mixtures of metal oxides and hydroxides. The hydroxides and oxides are preferably in platelet form (e.g., nanoplatelet form), although other configurations can also be prepared (e.g., tubes such as nanotubes).

Hydroxide in nanoparticulate form, e.g., nanoplatelet form, can be purchased from Aqua Resources Corporation or prepared by any suitable method so as to form the core including the method owned Aqua Resources Corporation described in U.S. Pat. Nos. 7,892,447, 7,736,485, 8,822,030, 10,273,163, and 9,604,854.

These nanoparticles can be added to a pesticide composition or processing aid to advantageously form non-covalent and non-ionic interactions with the active ingredients or processing aid of the composition, to reduce the volatility of the active ingredients or processing aid. The methodology can be used to prolong the biocidal effect or functional of the composition when applied to a surface. Such a mixture of nanoparticulates and an active ingredient or food additive, such as an essential oil, is shown in FIG. 1.

Some embodiments of the disclosure relate to a composition for controlling pests comprising at least one active ingredient as depicted in 40 CFR 152.25(f), water and a metal oxide. In some embodiments, the composition further comprises a metal hydroxide. In some embodiments, the metal hydroxide is in the form of nanoparticles. In some embodiments, the nanoparticles are in the form of nanoplatelets having a metal hydroxide monolayer. In some embodiments, the pests controlled by the composition are selected from the group consisting of microbes, bacteria, beetles, roaches, flies, ants, insect larvae, lice, fleas, mosquitos, ticks, thrips, aphids, moths and combinations thereof. In some embodiments, the pests are microbes or bacteria. In some embodiments, at least one active ingredient is selected from the group consisting of thyme oil, cinnamon oil, citronella oil, clove oil, eucalyptus oil, fennel oil, ginger oil, nutmeg oil, garlic oil, rosemary oil, sandalwood oil, lemongrass oil, mint oil, orange oil, peppermint oil, rosemary oil, tea tree oil, active ingredient, and combinations thereof. In some embodiments, at least one oil includes thyme oil. In some embodiments, the composition comprises not greater than 5% oil by weight. In some embodiments, the metal oxide is selected from the group consisting of MgO, FeO, Fe₂O₃ and ZnO. In some embodiments, the metal oxide is MgO. In some embodiments, the ready to use (RTU) composition comprises not greater than 1% of the metal oxide by weight. In some embodiments, the metal hydroxide is selected from the group consisting of Mg(OH)₂, Fe(OH)₃ and Zn(OH)₂. In some embodiments, the metal hydroxide is Mg(OH)₂. In some embodiments, the nanoplatelets have an average platelet diameter of from about 40 nm to about 120 nm. In some embodiments, the nanoplatelets have an average platelet diameter from about 30 nm to about 100 nm. In some embodiments, the composition is a concentrate. In some embodiments, the composition contains not less than 50% water by weight.

In a second aspect, a method for controlling pests is provided, the method comprising the steps of applying a composition to a surface, the composition comprising at least one active ingredient, oil, water and a metal oxide, wherein the composition is capable of killing or deterring pests. In some embodiments of the second aspect, the pests are selected from microbes, beetles, roaches, flies, ants, insect larvae, lice, fleas, mosquitos, ticks, thrips, aphids, moths and combinations thereof. In some embodiments, the pests are microbes. In some embodiments, applying the composition by immersion or adhesion to a surface comprises at least one of wiping, brushing, immersion or spraying the composition onto the surface. In some embodiments, the surface is selected from metals, polymers, ceramics, fabrics, and foods. In some embodiments, the method includes applying a composition further comprising a metal hydroxide. In some embodiments of the second aspect, the metal hydroxide is in the form of nanoparticles. In some embodiments, the nanoparticles are in the form of nanoplatelets having a metal hydroxide monolayer. In some embodiments of the second aspect, the method includes applying a composition selected from thyme oil, cinnamon oil, citronella oil, clove oil, eucalyptus oil, fennel oil, ginger oil, nutmeg oil, garlic oil, rosemary oil, sandalwood oil, lemongrass oil, mint oil, orange oil, peppermint oil, rosemary oil, tea tree oil, active ingredient, and combinations thereof. In some embodiments, the oil includes thyme oil. In some embodiments of the second aspect, the composition comprises not greater than 5% oil by weight. In some embodiments, the metal oxide is selected from the group consisting of MgO, FeO, Fe₂O₃ and ZnO. In some embodiments, the metal oxide is MgO. In some embodiments, the composition comprises not greater than 18% of the metal oxide by weight. In some embodiments, the metal hydroxide is selected from the group consisting of Mg(OH)₂, Fe(OH)₃ and Zn(OH)₂. In some embodiments, the metal hydroxide is Mg(OH)₂. In some embodiments of the second aspect, the nanoplatelets have an average platelet diameter of from about 100 nm to about 800 nm. In some embodiments, the nanoplatelets have an average platelet diameter of from about 30 nm to about 100 nm.

In a third aspect, a method of reducing vaporization of the active ingredients in a pesticide composition or processing aid is provided, wherein the active ingredients are non-covalently attracted to the monolayer such that vaporization of the active ingredients is reduced. In some embodiments, the vaporization of the active ingredients is reduced such that the active ingredients demonstrate a biocidal or functional effect for at least 30 hours. In some embodiments, the vaporization of the active ingredients is reduced such that the active ingredients demonstrate a biocidal or functional effect for at least 60 hours. In some embodiments, the vaporization of the active ingredients is reduced such that the active ingredients demonstrate a biocidal or functional effect for at least 180 hours. In some embodiments, the vaporization of the active ingredients or processing aid of the composition is reduced between about 5% to 100%.

### BRIEF DESCRIPTION OF THE DRAWINGS

FIG. 1 is a scanning transmission electron micrograph image of Mg(OH)₂ nanoparticles and thyme oil.

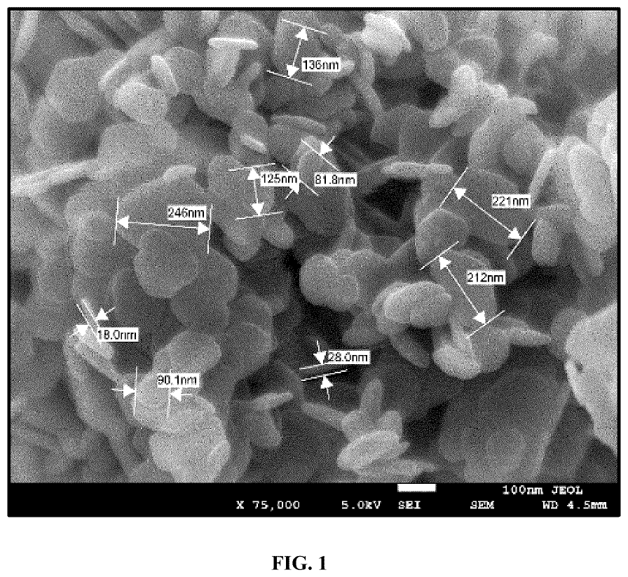

FIG. 2 shows the effect on bacterial populations from samples of flasks containing (a) water; (b) nanoplatelets; (c) thyme oil; and (d) bound thyme oil and nanoplatelets that were inoculated with bacteria from chicken homogenate 2 min and 1 h after inoculation.

FIG. 3 shows the effect on bacterial populations where flasks were reinoculated with bacteria from chicken homogenate after 10 h in flasks containing thyme oil and bound thyme oil with nanoplatelets.

FIG. 4 shows the effect on bacterial populations after reinoculation with bacteria from chicken homogenate after 60 h in flasks containing thyme oil and bound thyme oil with nanoplatelets.

FIG. 5 shows the effect on bacterial populations after reinoculation with bacteria from chicken homogenate after 180 h in flasks containing thyme oil and bound thyme oil with nanoplatelets.

FIG. 6 shows the quantity of bacterial populations in flasks containing thyme oil and bound thyme oil with nanoplatelets over 204 h with reinoculation at 10 h, 60 h, and 180 h.

FIG. 7 shows the efficacy of nanoplatelet formulations having concentrations of 1 mg/mL, 5 mg/mL, and 10 mg/mL compared to levoflaxin in killing and controlling S. aureus (MRSA) for 24 h.

FIG. 8 shows the efficacy of nanoplatelet formulations having concentrations of 1 mg/mL and 5 mg/mL compared to colistin (2 μg/mL) in treating carbapaenem-resistant E. coli for 24 h.

FIG. 9 shows the mitigation of Bacillus atrophaeus (Ames) bacteria by 5 mg/mL and 10 mg/mL concentrations of nanoplatelet formulations.

FIG. 10 shows the growth of T. rubrum after 3 days following exposure to nanoplatelets compared to growth without nanoplatelet exposure.

FIG. 11 shows inhibition of mold growth by nanoplatelet formulations with and without copper hydroxide compared to a commercial mold inhibitor for 76 h and for 24 h following reinoculation.

FIG. 12 shows control of bacterial growth on ground pork in cold water (4° C./39° F.) by nanoplatelets

FIG. 13 shows a synergistic effect in the control of Listeria monocytogenes using nanoplatelets with sodium metasilicate.

### DETAILED DESCRIPTION OF THE DISCLOSURE

The present disclosure can be understood more readily by referencing the following detailed description, examples, drawings, and claims, and their previous and following descriptions. However, before the present methods are disclosed and described, it is to be understood that this disclosure is not limited to the specific methods disclosed unless otherwise specified. It is also to be understood that the terminology used herein is for the purpose of describing particular aspects only and is not necessarily intended to be limiting.

This description is provided as an enabling teaching of the disclosure. To this end, those skilled in the relevant art will recognize and appreciate that many changes can be made to the various aspects of the disclosure described herein while still obtaining beneficial results. It will also be apparent that some of the desired benefits can be obtained by selecting some of the features described herein without utilizing other features. Accordingly, those who work in the art will recognize that many modifications and adaptations to the present description are possible and can even be desirable in certain circumstances and are a part of the present disclosure. Thus, this description is provided as illustrative of certain principles of the present disclosure and not in limitation thereof.

### Definitions

Unless defined otherwise, all technical and scientific terms used herein have the same meaning as is commonly understood by one of ordinary skill in the art. All patents, applications, published applications, and other publications referenced herein are incorporated by reference in their entirety unless stated otherwise. In the event that there are a plurality of definitions for a term herein, those in this section prevail unless stated otherwise.

Hereinafter, the term “h” means “hour” or “hours”; “min” means “minute” or “minutes”; “RI” means “reinoculation.”

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the term “metal hydroxide” is employed to refer to a metal hydroxide, a metal oxide, or mixtures thereof. More reactive metal oxides and hydroxides form the core, and are less reactive than the shell ions. The core metal oxides and hydroxides include but are not limited to scandium, titanium, vanadium, chromium, manganese, iron, cobalt, nickel, zinc, yttrium, zirconium, niobium, molybdenum, technetium, ruthenium, rhodium, palladium, silver, cadmium, hafnium, tantalum, tungsten, rhenium, osmium iridium, platinum, copper, gold, mercury, rutherfordium, dubnium, seaborgium, bohrium, hassium, meitnerium, ununnilium, ununennium, ununbium lanthanum, cerium, praseodymium, neodymium, promethium, samarium, europium, gadolinium, terbium, dysprosium, holmium, erbium, thulium, ytterbium, lutetium, actinium, thorium, protactinium, uranium, neptunium, plutonium, americium, curium, berkelium, californium, einsteinium, fermium, mendelevium, nobelium, and lawrencium. mixed oxides and hydroxides of the foregoing metals, mixed metal oxides and/or hydroxides, and other combinations thereof.

While the disclosure has been illustrated and described in detail in the drawings and foregoing description, such illustration and description are to be considered illustrative or exemplary and not restrictive. The disclosure is not limited to the disclosed embodiments. Variations to the disclosed embodiments can be understood and effected by those skilled in the art in practicing the claimed disclosure, from a study of the drawings, the disclosure and the appended claims.

All references cited herein are incorporated herein by reference in their entirety. To the extent publications and patents or patent applications incorporated by reference contradict the disclosure contained in the specification, the specification is intended to supersede and/or take precedence over any such contradictory material.

Unless otherwise defined, all terms (including technical and scientific terms) are to be given their ordinary and customary meaning to a person of ordinary skill in the art, and are not to be limited to a special or customized meaning unless expressly so defined herein. It should be noted that the use of particular terminology when describing certain features or aspects of the disclosure should not be taken to imply that the terminology is being re-defined herein to be restricted to include any specific characteristics of the features or aspects of the disclosure with which that terminology is associated. Terms and phrases used in this application, and variations thereof, especially in the appended claims, unless otherwise expressly stated, should be construed as open ended as opposed to limiting. As examples of the foregoing, the term ‘including’ should be read to mean ‘including, without limitation,’ ‘including but not limited to,’ or the like; the term ‘comprising’ as used herein is synonymous with ‘including,’ ‘containing,’ or ‘characterized by,’ and is inclusive or open-ended and does not exclude additional, unrecited elements or method steps; the term ‘having’ should be interpreted as ‘having at least;’ the term ‘includes’ should be interpreted as ‘includes but is not limited to;’ the term ‘example’ is used to provide exemplary instances of the item in discussion, not an exhaustive or limiting list thereof; adjectives such as ‘known’, ‘normal’, ‘standard’, and terms of similar meaning should not be construed as limiting the item described to a given time period or to an item available as of a given time, but instead should be read to encompass known, normal, or standard technologies that may be available or known now or at any time in the future; and use of terms like ‘preferably,’ ‘preferred,’ ‘desired,’ or ‘desirable,’ and words of similar meaning should not be understood as implying that certain features are critical, essential, or even important to the structure or function of the invention, but instead as merely intended to highlight alternative or additional features that may or may not be utilized in a particular embodiment of the invention. Likewise, a group of items linked with the conjunction ‘and’ should not be read as requiring that each and every one of those items be present in the grouping, but rather should be read as ‘and/or’ unless expressly stated otherwise. Similarly, a group of items linked with the conjunction ‘or’ should not be read as requiring mutual exclusivity among that group, but rather should be read as ‘and/or’ unless expressly stated otherwise.

As used in the claims below and throughout this disclosure, by the phrase “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity. The indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. Any reference signs in the claims should not be construed as limiting the scope.

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

All numbers expressing quantities of ingredients, reaction conditions, and so forth used in the specification are to be understood as being modified in all instances by the term ‘about.’ Accordingly, unless indicated to the contrary, the numerical parameters set forth herein are approximations that may vary depending upon the desired properties sought to be obtained. At the very least, and not as an attempt to limit the application of the doctrine of equivalents to the scope of any claims in any application claiming priority to the present application, each numerical parameter should be construed in light of the number of significant digits and ordinary rounding approaches.

Furthermore, although the foregoing has been described in some detail by way of illustrations and examples for purposes of clarity and understanding, it is apparent to those skilled in the art that certain changes and modifications may be practiced. Therefore, the description and examples should not be construed as limiting the scope of the invention to the specific embodiments and examples described herein, but rather to also cover all modification and alternatives coming with the true scope and spirit of the invention.

### Compostions

Aspects of the present disclosure relate a composition for controlling pests, which may comprise at least one active ingredient as depicted in 40 CFR 152.25(f), water, and a metal oxide. In some embodiments, the composition may further comprise a metal hydroxide. In some embodiments, the metal hydroxide can be in the form of nanoparticles. In some further embodiments, the nanoparticles can be in the form of nanoplatelets having a metal hydroxide or metal oxide monolayer.

In some embodiments, the composition can control, reduce, or eliminate pests, including microbes, beetles, roaches, flies, ants, insect larvae, lice, fleas, mosquitos, ticks, thrips, aphids, moths, and combinations thereof. In some embodiments, the pests can be microbes or bacteria.

In some embodiments, the at least one active ingredient as depicted in 40 CFR 152.25(f) can be an oil. In some embodiments, the at least one active ingredient can be selected from the group consisting of thyme oil, cinnamon oil, citronella oil, clove oil, eucalyptus oil, fennel oil, ginger oil, nutmeg oil, garlic oil, rosemary oil, sandalwood oil, lemongrass oil, mint oil, orange oil, peppermint oil, rosemary oil, tea tree oil, or another active ingredient as depicted in 40 CFR 152.25(f), and combinations thereof. In some embodiments, the at least one active ingredient includes thyme oil. In some embodiments, the at least one active ingredient can be an oil, and the composition comprises not greater than 5% by weight. In some embodiments, the composition can be a concentrate. In some embodiments, the composition contains not less than 50% water by weight.

In some embodiments, the composition can further comprise a salt. In some embodiments, the salt may be a sodium salt. In other embodiments, the salt may be a silicate. In some embodiments, the salt may be sodium metasilicate, Na₂SiO₃.

In some embodiments, the metal oxide can be selected from the group consisting of MgO, FeO, Fe₂O₃, and ZnO. In some embodiments, the metal oxide is MgO. In some embodiments, the composition comprises not greater than 1% of the metal oxide by weight. In some embodiments, the composition can further include a metal hydroxide, wherein the metal hydroxide. In some embodiments, the metal hydroxide can be selected from the group consisting of Mg(OH)₂, Fe(OH)₃ and Zn(OH)₂. In some embodiments, the metal hydroxide can be Mg(OH)₂.

In some embodiments, the metal hydroxide can be in the form of nanoparticles. In some embodiments, the nanoparticles are in the form of nanoplatelets. In some embodiments, the nanoplatelets can have an average platelet diameter of from about 100 nm to about 800 nm. In some embodiments, the average platelet diameter may be at any of the following values or between any of the two following values: 100 nm, 125 nm, 150 nm, 175 nm, 200 nm, 225 nm, 250 nm, 275 nm, 300 nm, 325 nm, 350 nm, 375 nm, 400 nm, 425 nm, 450 nm, 475 nm, 500 nm, 525 nm, 550 nm, 575 nm, 600 nm, 625 nm, 650 nm, 675 nm, 700 nm, 725 nm, 750 nm, 775 nm, 800 nm or any value therebetween. In some embodiments, the nanoplatelets can have an average platelet diameter from about 30 nm to about 100 nm. In some embodiments, the nanoplatelets have an average platelet diameter at any of the following values or between any two of the following values. In some embodiments, the nanoplatelets have an average platelet diameter from about 30 nm, 35 nm, 40 nm, 45 nm, 50 nm, 55 nm, 60 nm, 65 nm, 70 nm, 75 nm, 80 nm, 85 nm, 90 nm, 95 nm, 100 nm, or any value therebetween. In some embodiments, the nanoplatelets can have an average platelet diameter of from about 30 nm to about 100 nm in the x-y axis. In some embodiments, the nanoplatelets can have a dimension in the z-axis from about 0.7 nm to about 20 nm. In some embodiments, the dimension of the nanoplatelets in the z-axis can be about 1 nm, 2 nm, 3 nm, 4 nm, 5 nm, 6 nm, 7 nm, 8 nm, 9 nm, 10 nm, 11 nm, 12 nm, 13 nm, 14 nm, 15 nm, 16 nm, 17 nm, 18 nm, 19 nm, 20 nm, or any value therebetween.

### Methods and Uses

Aspects of the present disclosure relate to a method of controlling pests comprising applying a composition to a surface. In some embodiments, the method may kill, reduce, eliminate or inhibit the pests. In some embodiments, the method may comprise applying a composition comprising at least one oil, water, and a metal oxide. In some embodiments, the method may control pests, selected from the group consisting of, but not limited to, microbes, beetles, roaches, flies, ants, insect larvae, lice, fleas, mosquitos, ticks, thrips, aphids, moths and combinations thereof. In some embodiments, the pests are microbes or bacteria. In some embodiments, In some embodiments, the bacteria can be gram-positive or gram-negative bacteria. In some embodiments, the bacteria may be anti-biotic resistant bacteria. In some embodiments, the pests are molds, fungi or fungal isolates. In some embodiments, the pests can be selected from the group consisting of Bacillus anthracis (Ames), Bacillus anthracis (Sterne), Bacillus cereus, Bacillus subtilis, Bacillus thuringiensis, Bacillus thuringiensis (Al Hakam), Escherichia coli, Klebsiella pneumoniae, Burkholderia phytofirmans, Proteus vulgaris, Pseudomonas aeruginosa, Salmonella typhinumrium, Propionibacterium species, Vancomycin-resistant MRSA (VRSA), Vibrio, Yersinia Pestis (black plague), Microbacteriaceae industrial isolates, Auerobasidium pullulans, Apergillus niger, Penicillium citrinum, Alternaria tenuissima, Trichophyton rubrum, Salmonella enterica, Campylobacter jejuni, Staphylococcus aureus (MRSA), Listeria monocytogenes, model recalcitrant viruses, Bacteriophage MS2, and SARS-CoV-2.

In some embodiments, the method of controlling pests may include at least one of immersing, wiping, brushing or spraying the composition onto the surface. In some embodiments, the surface may include, but is not limited to, metals, polymers, ceramics, and foods.

In some embodiments, the method of controlling pests or as a processing aid may include applying a composition to a surface, the composition further comprising a metal hydroxide. In some embodiments, the metal oxide or hydroxide is in the form of nanoparticles. In some embodiments, the nanoparticles are in the form of nanoplatelets having a metal hydroxide monolayer.

In some embodiments, at least one oil is selected from the group consisting of, but not limited to, thyme oil, cinnamon oil, citronella oil, clove oil, eucalyptus oil, fennel oil, ginger oil, nutmeg oil, garlic oil, rosemary oil, sandalwood oil, lemongrass oil, mint oil, orange oil, peppermint oil, rosemary oil, tea tree oil and combinations thereof. In some embodiments, the at least one oil includes thyme oil. In some embodiments, the composition comprises not greater than 5% oil by weight.

In some embodiments, the metal oxide is selected from the group consisting of, but not limited to, MgO, FeO, Fe₂O₃ and ZnO. In some embodiments, the metal oxide is MgO. In some embodiments, the composition comprises not greater than 18% of the metal oxide by weight.

In some embodiments, the metal hydroxide is selected from the group consisting of, but not limited to, Mg(OH)₂, Fe(OH)₃ and Zn(OH)₂. In some embodiments, the metal hydroxide is Mg(OH)₂.

In some embodiments, the nanoplatelets have an average platelet diameter from about 100 nm to about 800 nm. In some embodiments, the average platelet diameter may be at any of the following values or between any of the two following values: 100 nm, 125 nm, 150 nm, 175 nm, 200 nm, 225 nm, 250 nm, 275 nm, 300 nm, 325 nm, 350 nm, 375 nm, 400 nm, 425 nm, 450 nm, 475 nm, 500 nm, 525 nm, 550 nm, 575 nm, 600 nm, 625 nm, 650 nm, 675 nm, 700 nm, 725 nm, 750 nm, 775 nm, 800 nm or any value therebetween. In some embodiments, the nanoplatelets have an average platelet diameter from about 30 nm to about 100 nm. In some embodiments, the nanoplatelets have an average platelet diameter at any of the following values or between any two of the following values. In some embodiments, the nanoplatelets have an average platelet diameter from about 30 nm, 35 nm, 40 nm, 45 nm, 50 nm, 55 nm, 60 nm, 65 nm, 70 nm, 75 nm, 80 nm, 85 nm, 90 nm, 95 nm, 100 nm, or any value therebetween. In some embodiments, the nanoplatelets can have a dimension in the z-axis from about 0.7 nm to about 20 nm. In some embodiments, the dimension of the nanoplatelets in the z-axis can be about 1 nm, 2 nm, 3 nm, 4 nm, 5 nm, 6 nm, 7 nm, 8 nm, 9 nm, 10 nm, 11 nm, 12 nm, 13 nm, 14 nm, 15 nm, 16 nm, 17 nm, 18 nm, 19 nm, 20 nm, or any value therebetween.

Aspects of the present disclosure relate to a method of reducing vaporization of the active ingredients or processing aid of a composition. In some embodiments, the method may include exposing the active ingredients or processing aid to a plurality of nanoplatelets having a metal hydroxide monolayer. In some embodiments, the active ingredients of the pesticide composition are non-covalently and non-ionically attracted to the monolayer such that vaporization of the active ingredients or processing aid is reduced. In some embodiments, the vaporization of the active ingredients may be reduced by an amount equal to or greater than approximately 5%, 10%, 15%, 20%, 25%, 30%, 35%, 40%, 45%, 50%, 55%, 60%, 65%, 70%, 75%, 80%, 85%, 90%, 99%, 100%, or ranges including and/or spanning the aforementioned values.

In some embodiments, the vaporization of the active ingredients is reduced such that the active ingredients demonstrate a biocidal effect for at least 0.5 h, 1 h, 5 h, 10 h, 15 h, 20 h, 25 h, 30 h, 35 h, 40 h, 45 h, 50 h, 55 h, 60 h, 65 h, 70 h, 75 h, 80 h, 90 h, 95 h, 100 h, 110 h, 120 h, 130 h, 140 h, 150 h, 160 h, 170 h, 180 h, 190 h, 200 h, or ranges including and/or spanning the aforementioned values after applying the composition.

### EXAMPLES

The following examples are given for the purpose of illustrating various embodiments of the disclosure and are not meant to limit the present disclosure in any fashion. One skilled in the art will appreciate readily that the present disclosure is well adapted to carry out the objects and obtain the ends and advantages mentioned, as well as those objects, ends and advantages inherent herein. Changes therein and other uses which are encompassed within the spirit of the disclosure as defined by the scope of the claims will occur to those skilled in the art.

### Example 1: Effect of Bound Nanoplatelets with Thyme Oil on Bacteria in Chicken Breast Homogenate

Chicken breast homogenate was stored for 4 days at room temperature and 0.25 mL of the homogenate was added to flasks containing solutions of (a) 25 mL of water; (b) 0.1% solution of magnesium hydroxide nanoplatelets; (c) 0.1% thyme oil and (d) 0.1% bound magnesium hydroxide nanoplatelets and 0.1% thyme oil. The flasks were placed in a shaker-incubator (200 rpm) at room temperature (75° F.). Samples were taken from flasks at timed intervals, dilutions made and plated using a spiral plater, Neutec, Farmingdale, NY.

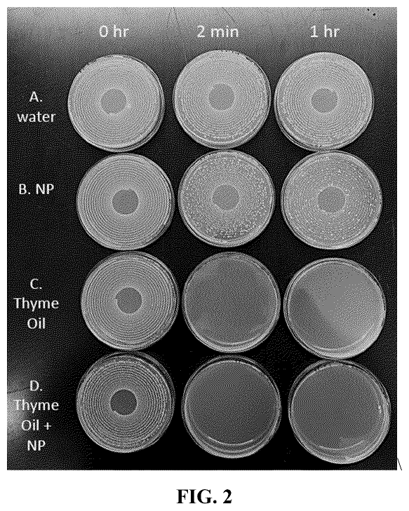

As shown in FIG. 2, after 2 minutes, flasks containing thyme oil or bound thyme oil and nanoplatelets had eliminated all bacteria (zero colonies on plates). After 1 h and 3 h (not shown), flasks containing thyme oil or bound thyme oil and nanoplatelets had eliminated all bacteria and had no regrowth (zero colonies on plates). When counted and plotted thyme oil and bound thyme oil with nanoplatelets produced greater than a log 7 kill of bacteria within 2 minutes.

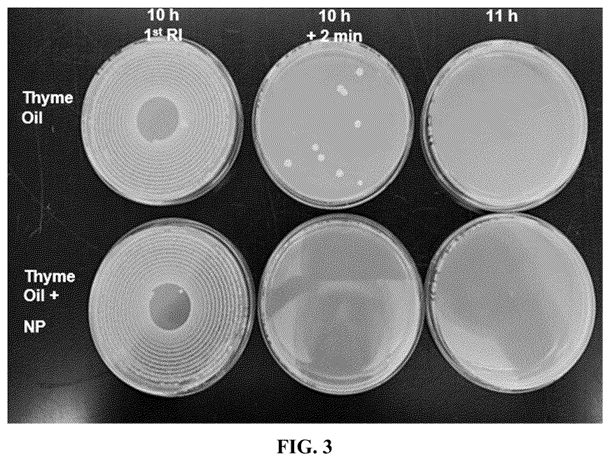

Flasks were then reinoculated with 0.25 mL homogenate at 10 h (1^{st} RI) and samples were taken and plated after 2 min and 1 h. As shown in FIG. 3, after 2 min, thyme oil alone did not completely eliminate bacteria. Thyme oil alone produced a log 4 kill within 2 minutes and then continued killing to produce a log 7 kill by 1 h. In contrast, for the bound thyme oil with nanoplatelets no bacteria were observed on the plate, indicating complete kill (log 7) within 2 minutes of reinoculation.

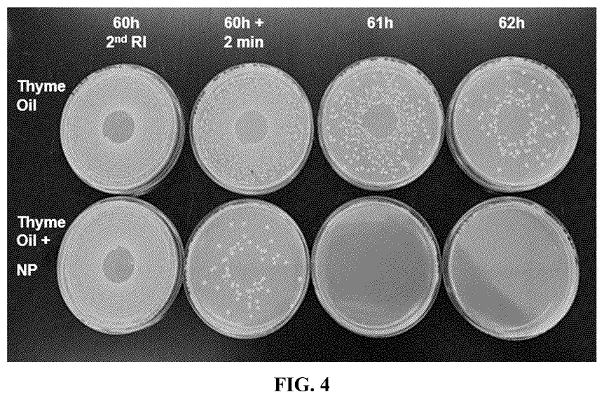

After 60 h, flasks were reinoculated with 0.25 mL of the original homogenate (2^{nd} RI). As shown in FIG. 4, bound thyme oil with nanoplatelets reduced the bacterial population substantially within 2 min and completely (approximately log 7 kill) in 1 h. Thyme oil alone reduced but did not eliminate bacteria within 2 h.

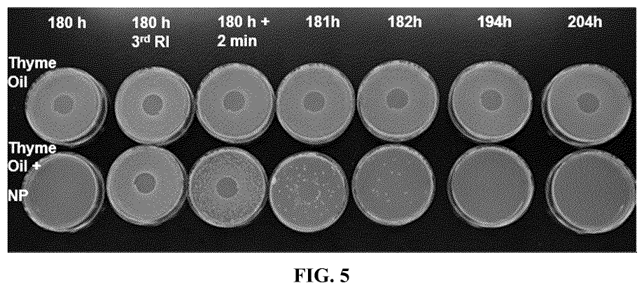

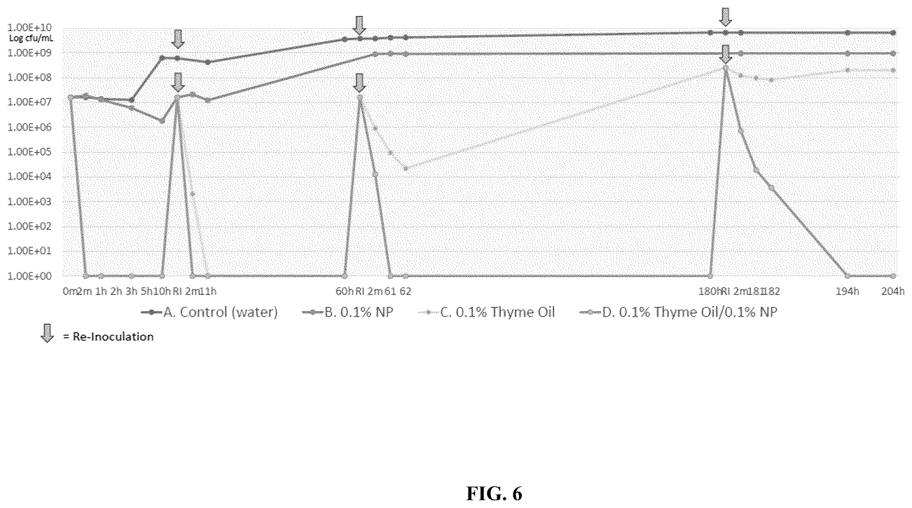

After 180 h, the flasks were inoculated reinoculated a third time (3^{rd} RI) with approximately log 8 bacteria. As shown in FIG. 5, bound thyme oil with nanoplatelets quickly reduced bacterial numbers with zero bacteria expected (based on extrapolation) around 186 h. Zero bacteria were observed at 194 h and maintained through 204 h. Thyme oil alone was no longer effective. FIG. 6 shows the bacterial population measured over the course of 204 h. The data suggests that bound thyme oil with nanoplatelets can decrease the evaporation of the volatile organic compounds in thyme oil extending the biocidal effect of the thyme oil.

### Example 2: Efficacy of Composition Compared to Conventional Antibiotics

TABLE 1

| | Nanoplatelet | | | | |
|---|---|---|---|---|---|
| | Composition | | Antibiotic Parallel Tests | | |
| | Log | Time to | Antibiotic | Log | Time to |
| Pathogen | Kill | Zero | Used | Kill | Zero |
| MRSA | 7 Log | 3 hr | Levoflaxin | 4.5 Log | Not |
| (S. aureus) | | | | | reached |
| CRE | 8 Log | 3 hr | Tigecycline | 8 Log | 24 hr |
| (K. pneumoniae) | | | | | |
| CRE | 8 Log | 3 hr | Colistin | — | Not |
| (E. coli) | | | | | maintained |
| S. aureus | 7 Log | 3 hr | Linezolid | 0.5 | Not |
| (VISA) | | | | | reached |
| B. cereus | 8 Log | 1 hr | Cyproflaxin | 0.5 | Not |
| (ATCC 14579) | | | | | reached |
| B. anthracis | 6 Log | 6 hr | Not Tested | — | — |
| (Ames) | | | | | |

Table 1 compares the efficacy of the nanoplatelet compositions compared to conventional antibiotics. As can be seen from the data, the nanoplatelet compositions achieved a log kill reduction that was greater than or equal to the comparative antibiotics.

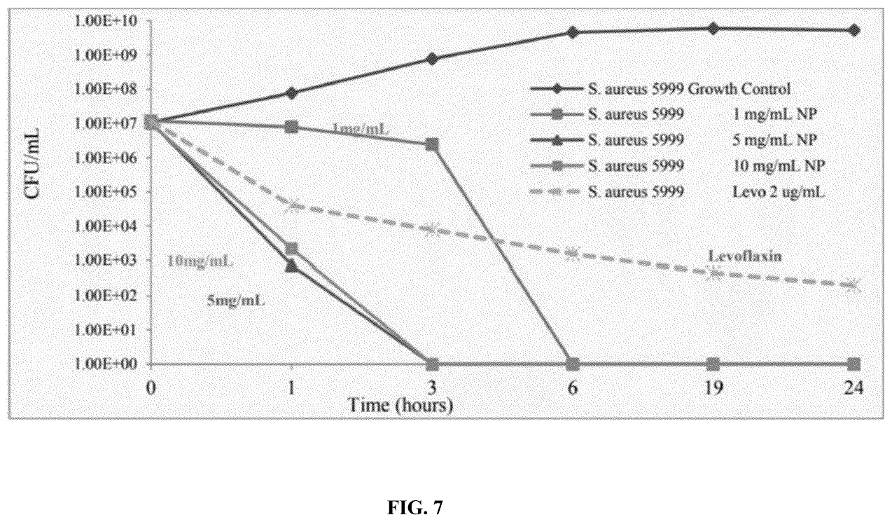

FIG. 7 shows the results of treating methicillin-resistant Staphylococcus aureus (MRSA) with the nanoplatelet composition compared to levoflaxin. The nanoplatelet composition achieved total mitigation of MRSA from a 7 log pathogen population (10 million bacteria per mL) to zero in 3 hours. Levoflaxin, a commonly administered antibiotic used for treating MRSA, was tested at clinical doses and is shown as the dashed line. At various concentrations, the nanoplatelet composition eliminated MRSA more completely than levoflaxin after 24 hours with no rebound.

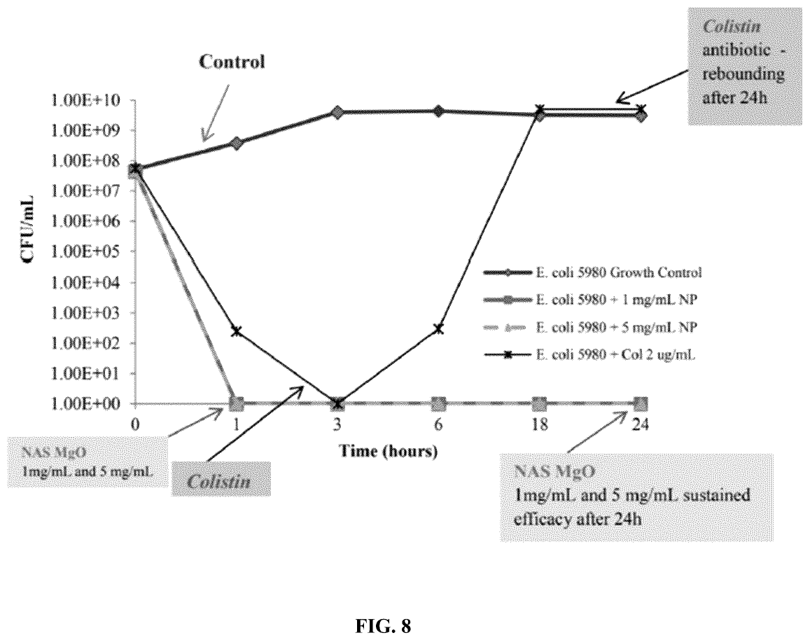

FIG. 8 shows the control of a CRE (carbapaenem-resistant Enterobacteriaceae) strain of E. coli by the nanoplatelet composition at various concentrations compared to colistin. The nanoplatelet compositions completely killed the bacteria population within 1 hour with no rebound The population treated with colistin completely rebounded within 24 hours.

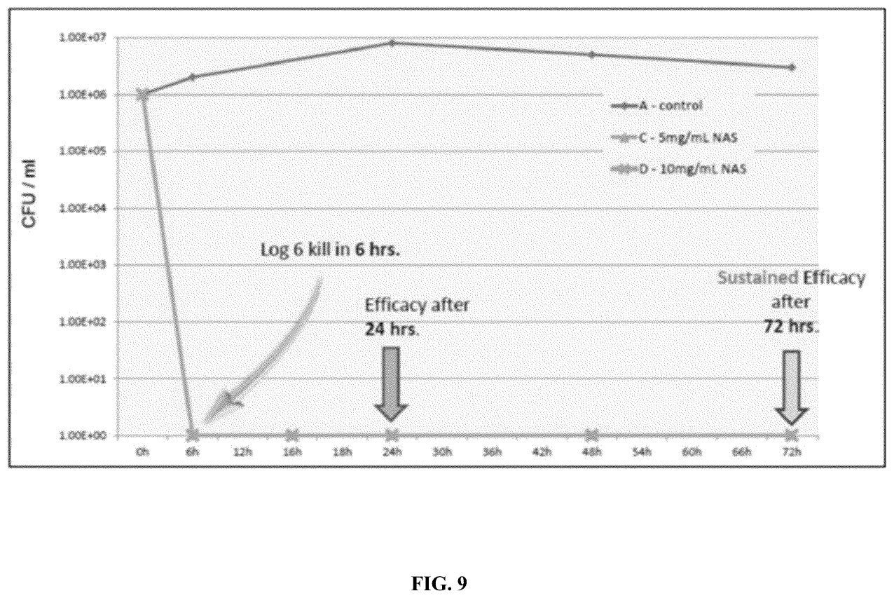

FIG. 9 shows the mitigation of Bacillus atrophaeus (Ames) bacteria and spores in liquid culture. A log 6 kill was achieved in 6 hours at both 5 mg/mL and 10 mg/mL concentrations (the lines overlap) with no bounce back or 2^{nd} generation growth for 72 hours.

### Example 3: Control of Trichophyton rubrum (Athlete's Foot Fungus)

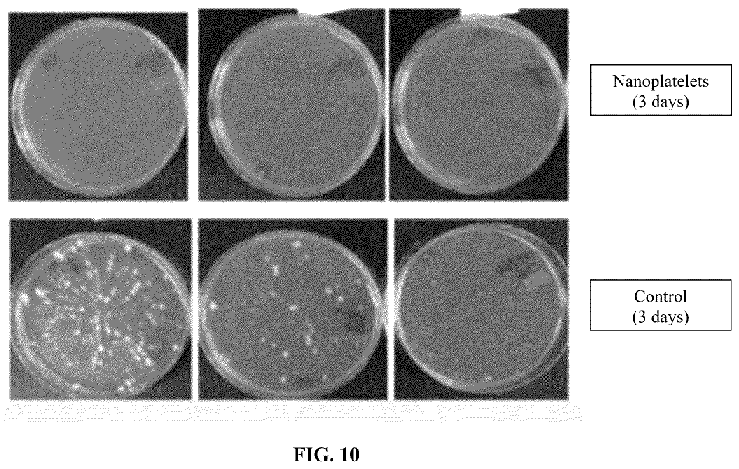

Cultures of T. rubrum were overlaid onto nanoplatelet compositions or added to blank wells of a multi-well plat as a control and allowed to incubate for 24 hours. The cultures were then removed and transferred onto nutrient agar plates. Growth was observed for 10 days. T. rubrum that had been exposed to the nanoplatelet compositions was eliminated and failed to show any growth over a 3-day period in contrast to the control plates as shown in FIG. 10. No growth was observed for the nanoplatelet treated culture plays after 10 days of incubation.

### Example 4: Mold Growth Inhibition Studies

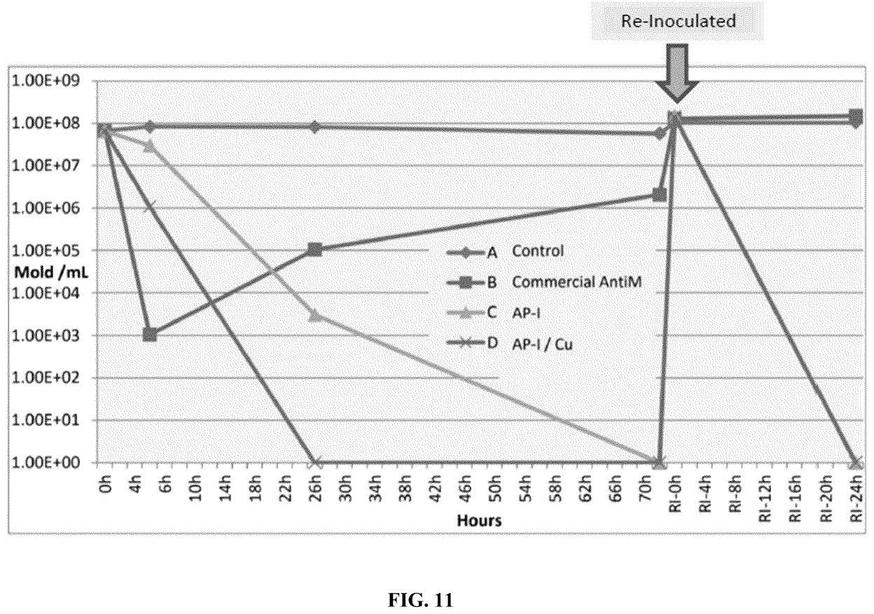

An environmental mold was captured from a wood yard, cultured, and subjected to growth inhibition studies. Flask cultures of the mold were grown for 6 hours before the addition of a standard commercial mold inhibitor mix, and a nanoplatelet formulation with or without copper hydroxide. As shown in FIG. 11, the commercial mix was initially fast to eliminate mold, but the inhibitor was quickly consumed, and the mold population began to regrow after 5 hours. By contrast, the nanoplatelet formulations, with (AP-I/Cu) and without copper hydroxide (AP-I), eliminated the mold after 26 hours and 76 hours, respectively. Following reinoculation, both nanoplatelet formulations eliminated the newly introduced mold within around 24 hours, whereas the commercial mold inhibitor had no effect.

### Example 5: Bacterial Control in Pork

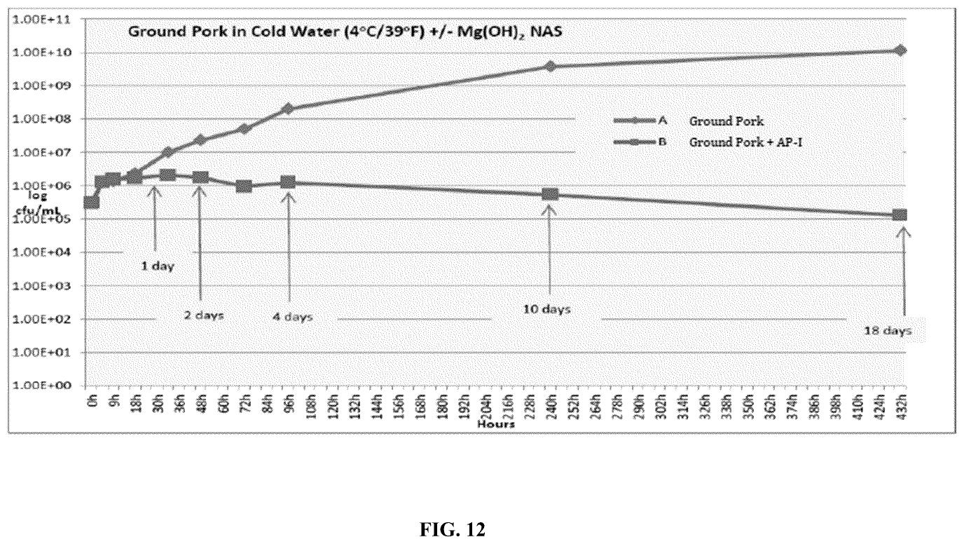

FIG. 12 shows the efficacy of a nanoplatelet formulation with magnesium hydroxide for control of bacterial growth on ground pork in cold water (4° C./39° F.). Pork treated with the nanoplatelet composition (AP-I) showed no growth and even a slight reduction of bacteria after 18 days.

### Example 6: Synergistic Effect in Control of Listeria monocytogenes in Use of Sodium Metasilicate with Nanoplatelet Formulations

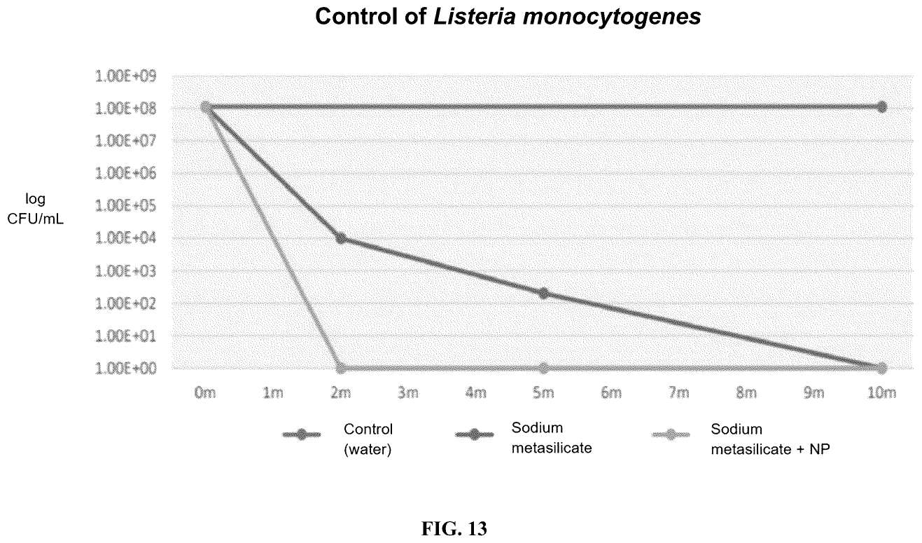

FIG. 13 shows the efficacy of nanoplatelet formulation (AP-II) that includes sodium metasilicate (Subcomponent-II) against Listeria monocytogenes, a pathogenic bacterial species that is problematic in the chicken processing industry. The nanoplatelet formulation (0.1%) produced an 8 log kill in less than 2 minutes. Identical results were obtained with E. coli and Salmonella enterica. Elimination of bacteria was observed after minutes, and no rebound was observed after 6 hours. Compared to use of sodium metasilicate alone, FIG. 13 shows that the nanoplatelets and sodium metasilicate appear to work synergistically in reducing the bacteria population.

### Example 7: Field Tests

Tests were conducted wherein various plants were treated with nanoplatelet formulations. In one study, strawberry plants in Baker, Florida were treated with the nanoplatelet formulations. Treatment resulted in a 41.5% increase in yield compared to control studies and a 14.5% increase in berry weight. Treated plants did not require application of chloropicrin to control soil bacteria and Chaetosiphon aphids were controlled with one application of the nanoplatelet formulation. In addition, pythium root rot found was eradicated with one application.

Another study examined growth of cloned cannabis plants in Michigan and New York. Plants treated with the nanoplatelet compositions outperformed untreated plants in all measured areas. Treated plants showed a 30-40% increase in overall plant size, a 30-50% increase in stalk size and strength. Treat plants also showed a 25%-50% increase in flowers and 25-40% increase in yield. No fungus of any kind was observed on treated plants and a drought event of one week showed no damage on treated plants.

Studies were also conducted on green bean plants, cantaloupe plants, and pepper plants. First application of the nanoplatelet composition was made when the bean plants first emerged or after transplanting. Subsequent applications were made every 2 weeks until harvest or until cantaloupe plants were beginning to have blooms. Treated green bean plants showed a 29.4% yield increase. Treated cantaloupe plants had a 21.3% increase in the number of fruit and a 20.4% increase in weight. Treated pepper plants showed a 19.1% increase in number of peppers and a 15.9% increase in bushels per acre.

Additional studies on grapes in a New York vineyard showed no mildew, bacteria, or pest damage on treated vines and did not require application of additional pesticides or antimicrobial products. In addition, the harvest date for treated vines was accelerated by almost 30 days and grapes grown on treated vines were found to have a superior taste.

What is claimed is:

1. A composition for controlling pests comprising at least one active ingredient as depicted in 40 CFR 152.25(f), water, and a metal oxide.

2. The composition of claim 1, wherein the composition further comprises a metal hydroxide.

3. The composition of claim 2, wherein the metal hydroxide is in the form of nanoparticles.

4. The composition of claim 3, wherein the nanoparticles are in the form of nanoplatelets having a metal hydroxide or metal oxide monolayer.

5. The composition of claim 1, wherein the pests are selected from the group consisting of microbes, beetles, roaches, flies, ants, insect larvae, lice, fleas, mosquitos, ticks, thrips, aphids, moths, and combinations thereof.

6. The composition of claim 5, wherein the pests are microbes or bacteria.

7. The composition of claim 1, wherein the at least one active ingredient is selected from the group consisting of thyme oil, cinnamon oil, citronella oil, clove oil, eucalyptus oil, fennel oil, ginger oil, nutmeg oil, garlic oil, rosemary oil, sandalwood oil, lemongrass oil, mint oil, orange oil, peppermint oil, rosemary oil, tea tree oil, and combinations thereof.

8. The composition of claim 7, wherein the at least one active ingredient includes thyme oil.

9. The composition of claim 7, wherein the composition comprises not greater than 5% oil by weight.

10. The composition of claim 1, wherein the composition further comprises sodium metasilicate.

11. The composition of claim 1, wherein the metal oxide is selected from the group consisting of MgO, FeO, Fe₂O₃, and ZnO.

12. The composition of claim 11, wherein the metal oxide is MgO.

13. The composition of claim 1, wherein the composition comprises not greater than 1% of the metal oxide by weight.

14. The composition of claim 2, wherein the metal hydroxide is selected from the group consisting of Mg(OH)₂, Fe(OH)₃ and Zn(OH)₂.

15. The composition of claim 14, wherein the metal hydroxide is Mg(OH)₂.

16. The composition of claim 5, wherein the nanoplatelets have an average platelet diameter of from about 100 nm to about 800 nm.

17. The composition of claim 16, wherein the nanoplatelets have an average platelet diameter of from about 30 nm to about 100 nm.

18. The composition of claim 5, wherein the nanoparticles have a dimension in the z-axis of from about 0.7 nm to about 20 nm.

19. A method for controlling pests, the method comprising applying a composition to a surface, the composition comprising at least one oil, water and a metal oxide, wherein the composition is capable of killing or deterring pests.

20. A method of reducing vaporization of the active ingredients in a pesticide composition, comprising:
exposing the active ingredients to a plurality of nanoplatelets having a metal hydroxide or metal oxide monolayer, wherein the active ingredients are non-covalently or non-ionically attached to the hydroxide monolayer such that vaporization of the active ingredients is reduced.
